(19) United States
(12) Patent Application Publication
(10) Pub. No.: US 2020/0285874 A1
(43) Pub. Date: Sep. 10, 2020

(54) BIOMETRIC AUTHENTICATION DEVICE AND COMPUTER PROGRAM PRODUCT

(71) Applicant: FUJITSU CLIENT COMPUTING LIMITED, Kanagawa (JP)

(72) Inventors: Masaki Mukouchi, Kawasaki (JP); Satoshi Inage, Kawasaki (JP)

(73) Assignee: FUJITSU CLIENT COMPUTING LIMITED, Kanagawa (JP)

(21) Appl. No.: 16/745,176

(22) Filed: Jan. 16, 2020

(30) Foreign Application Priority Data
Mar. 7, 2019 (JP) 2019-041910

(51) Int. Cl. G06K 9/00

(52) U.S. Cl. CPC G06K 9/00912; G06K 9/00013; G06K 9/00604; G06K 9/00926

(57) ABSTRACT

A biometric authentication device includes: a receiver that receives an input of identification information of a person to authenticate; an image acquirer that acquires an image of a predetermined part of the person to authenticate from a camera; a guide display control that displays, on a display, a guiding shape and the image acquired by the image acquirer irrespective of whether the identification information received by the receiver is registered in a file containing registered identification information of persons; and an authenticator that authenticates the person based on the image acquired by the image acquirer. The guiding shape for position adjustment of the predetermined part with respect to the camera.

### CROSS-REFERENCE TO RELATED APPLICATIONS

This application is based upon and claims the benefit of priority from Japanese Patent Application No. 2019-041910, filed Mar. 7, 2019, the entire contents of which are incorporated herein by reference.

### FIELD

Embodiments described herein relate generally to a biometric authentication device and a computer program product.

### BACKGROUND

Conventionally, biometric authentication devices are known, which receive an input of identification information from a person being a subject of authentication and images the palm of the person with a camera, to authenticate the person on the basis of the palm image and collation-use biological information, for example. One of such biometric authentication devices includes a display that displays a guiding shape for guiding the person to place his or her palm in an appropriate position with respect to the camera at the time of imaging with the camera.

After determining that the input identification information has not been registered, the biometric authentication device displays not the guiding shape but error information on the display. In this case, the person who has input the identification information can infer no registration of the identification information.

It is preferable to provide a biometric authentication device and a computer program product which make inference of a registration status of identification information difficult.

### SUMMARY

According to one aspect of this disclosure, a biometric authentication device includes a receiver that receives an input of identification information of a person to authenticate; an image acquirer that acquires an image of a predetermined part of the person to authenticate from a camera; a guide display control that displays, on a display, a guiding shape and the image acquired by the image acquirer irrespective of whether the identification information received by the receiver is registered in a file containing registered identification information of persons, the guiding shape being for position adjustment of the predetermined part with respect to the camera; and an authenticator that performs authentication of the person based on the image acquired by the image acquirer.

### BRIEF DESCRIPTION OF THE DRAWINGS

FIG. 1 is a perspective view illustrating an exemplary electronic device according to an embodiment;

FIG. 2 is a diagram illustrating an exemplary guide screen displayed on a display of the electronic device according to the embodiment;

FIG. 3 is a block diagram illustrating an exemplary configuration of the electronic device according to the embodiment;

FIG. 4 is a diagram illustrating an exemplary registration file according to the embodiment;

FIG. 5 is a block diagram illustrating an exemplary functional configuration of the electronic device according to the embodiment;

FIG. 6 is a flowchart illustrating exemplary registration processing performed by a control unit of the electronic device according to the embodiment;

FIG. 7 is an explanatory diagram illustrating an example of placing a relatively large hand in front of a camera according to the embodiment;

FIG. 8 is an explanatory diagram illustrating an example of placing a relatively small hand in front of the camera according to the embodiment;

FIG. 9 is a diagram illustrating an exemplary image generated by the camera in FIG. 7 in the embodiment;

FIG. 10 is a diagram illustrating an exemplary image generated by the camera in FIG. 8 in the embodiment;

FIGS. 11A and 11B are explanatory diagrams illustrating an exemplary method of determining an outline image of a palm according to the embodiment;

FIG. 12 is a flowchart illustrating exemplary biometric authentication performed by the control unit of the electronic device according to the embodiment;

FIG. 13 is a diagram illustrating an exemplary guide screen displaying a dummy guiding shape on the display of the electronic device according to the embodiment;

FIG. 14 is a diagram illustrating a relationship between a certain ID and ASCII codes in the embodiment;

FIG. 15 is a diagram illustrating an exemplary registration file according to a first modification of the embodiment; and

FIGS. 16A and 16B are diagrams illustrating a method of determining a guiding shape according to a second modification of the embodiment.

### DETAILED DESCRIPTION

The following will disclose an exemplary embodiment of this disclosure. Features of the following embodiment, and operations and effects implemented by the features are merely exemplary and unintended to limit the scope of the present invention. This disclosure can be implemented by features other than the ones disclosed in the following embodiment. This disclosure can provide at least one of various effects including derivative effects attained by the features.

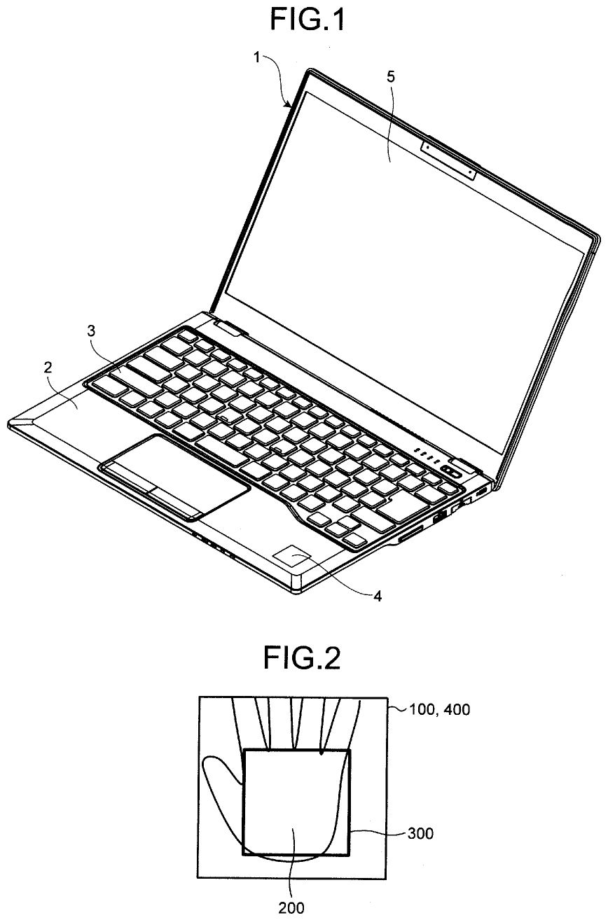

FIG. 1 is a perspective view illustrating an exemplary electronic device 1 according to the embodiment. As illustrated in FIG. 1, for example, the electronic device 1 serves as a laptop or clamshell personal computer, and includes a base housing 2, an input unit 3, a camera 4, and a display 5. The electronic device 1 is not limited to this example, and may be, for example, a desktop personal computer, a slate or tablet personal computer, a smartphone, a cellular phone, a video display, a television receiver set, and a game machine.

FIG. 2 is a diagram illustrating an exemplary guide screen 100 displayed on the display 5 of the electronic device 1 according to the embodiment. The electronic device 1 performs biometric authentication upon startup, for example. Examples of the biometric authentication include palm vein authentication. In the biometric authentication, first, the display 5 displays an ID input screen (not illustrated) for receiving an input of an ID as identification information which allows user identification. Hereinafter, the ID of the user is also referred to as a user ID. In response to input of the ID to the ID input screen, the display 5 displays the guide screen 100 as illustrated in FIG. 2, and the camera 4 starts imaging at the same time. The user places his or her palm 200 in front of the camera 4. The guide screen 100 displays a guiding shape 300 for position adjustment of the palm 200 with respect to the camera 4, and an image 400 generated by the camera 4. The guiding shape 300 and the image 400 are displayed in a superimposed manner. The user is subjected to authentication on the basis of the image 400. The biometric authentication will be described in detail later. The electronic device 1 is an exemplary authentication system. The user is an exemplary subject of authentication. The biometric authentication is not limited to the palm vein authentication. For example, the biometric authentication may be iris authentication using the iris of an eye, or fingerprint authentication.

The following describes respective elements of the electronic device 1 in detail.

As illustrated in FIG. 1, the input unit 3 is fixed to the base housing 2. The input unit 3 includes a keyboard and a touch pad.

The camera 4 is fixed to the base housing 2. The camera 4 serves as an area camera or an area sensor that can output a color or monochrome two-dimensional image of a subject (in the present embodiment, a human hand). The camera 4 has, for example, an imaging range of 60 degrees or greater. The imaging range of the camera 4 is not limited thereto. The camera 4 may not be a wide-angle camera.

The display 5 is supported by the base housing 2 in a rotatable manner. The display 5 is a liquid crystal display or an organic display, for example.

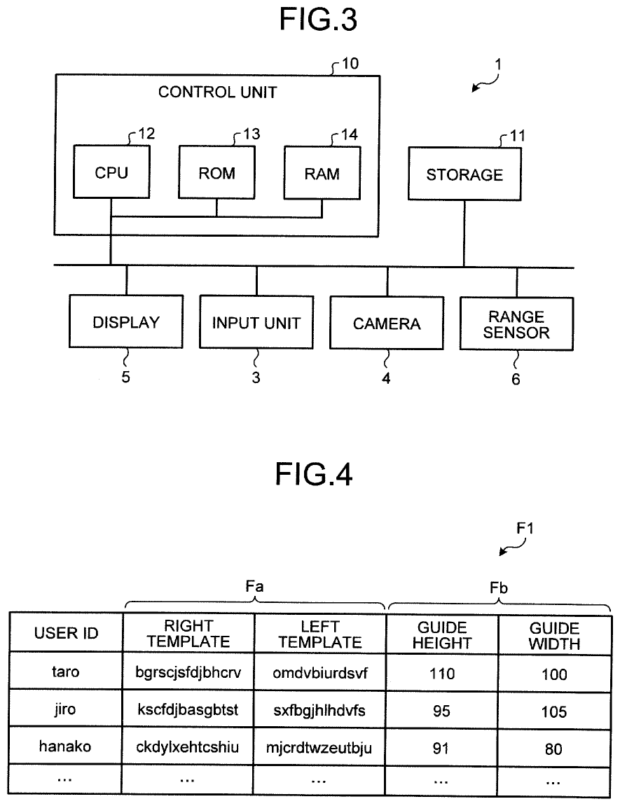

FIG. 3 is a block diagram illustrating an exemplary configuration of the electronic device 1 according to the embodiment. The electronic device 1 includes a control unit 10 and a storage 11.

The control unit 10 includes a central processing unit (CPU) 12, a read only memory (ROM) 13, and a random access memory (RAM) 14. That is, the control unit 10 has a hardware configuration of a typical computer. The CPU 12 reads and executes a computer program stored in the ROM 13 or the storage 11. The CPU 12 can execute various kinds of computation in parallel. The RAM 14 temporarily stores various kinds of data for use in the CPU 12's parallel computations by the computer program. The control unit 10 is connected to the display 5, the input unit 3, the camera 4, the storage 11, and a range sensor 6.

The storage 11 is, for example, a hard disk drive (HDD) or a solid state drive (SSD). The storage 11 stores an operating system (OS), a computer program, and various files. The various files stored in the storage 11 include a registration file F1 (FIG. 4). The registration file F1 is an exemplary file. The storage 11 is an exemplary recording medium on which the computer program is recorded.

FIG. 4 is a diagram illustrating the registration file F1 of the embodiment by way of example. As illustrated in FIG. 4, the registration file F1 contains registered IDs of users (in FIG. 4, user IDs). The registration file F1 stores collation-use biological information Fa and guide information Fb for each of the IDs of the users (in FIG. 4, user IDs). That is, the registration file F1 stores the IDs of the users, the collation-use biological information Fa, and the guide information Fb in association with one another. The collation-use biological information Fa is collated with the image 400 generated by the camera 4 through the biometric authentication. The collation-use biological information Fa is a template of an image of a vein of the palm 200. The collation-use biological information Fa includes a right template and a left template. The right template is collation-use biological information on the vein of the palm 200 of the user's right hand. The left template is collation-use biological information on the vein of the palm 200 of the user's left hand. The guide information Fb represents the guiding shape 300. In the present embodiment, the guiding shape 300 is a geometric shape by way of example. Specifically, the guiding shape 300 is a rectangular frame, and the guide information Fb includes a longitudinal (vertical in FIG. 2) length (in FIG. 4, guide height) of the guiding shape 300 and a lateral (horizontal in FIG. 2) length (in FIG. 2, guide width) thereof.

The range sensor 6 illustrated in FIG. 3 measures a distance between the camera 4 and the palm 200 as a subject. The range sensor 6 is fixed to the base housing 2.

Next, the following describes registration process and biometric authentication among various kinds of processing performed by the control unit 10.

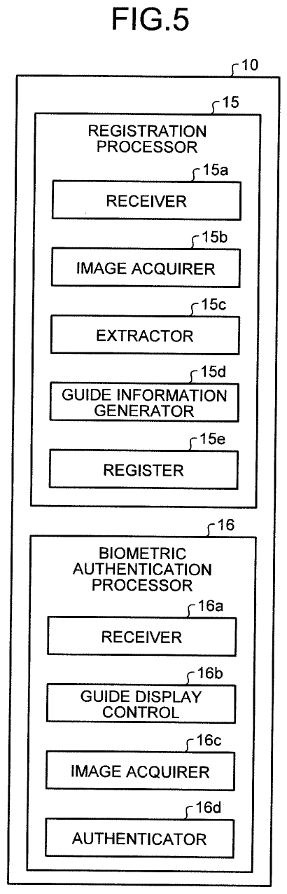

FIG. 5 is a block diagram illustrating an exemplary functional configuration of the electronic device 1 according to the embodiment. As illustrated in FIG. 5, the control unit 10 includes, as functional elements, a registration processor 15 that performs registration, and a biometric authentication processor 16 that performs biometric authentication. The registration processor 15 includes a receiver 15a, an image acquirer 15b, an extractor 15c, a guide-information generator 15d, and a register 15e. The biometric authentication processor 16 includes a receiver 16a, a guide display control 16b, an image acquirer 16c, and an authenticator 16d. Each of the functional elements is implemented by the CPU 12's execution of the computer program stored in storage such as the ROM 13 or the storage 11. Part or all of the functional elements may be implemented by dedicated hardware or circuitry.

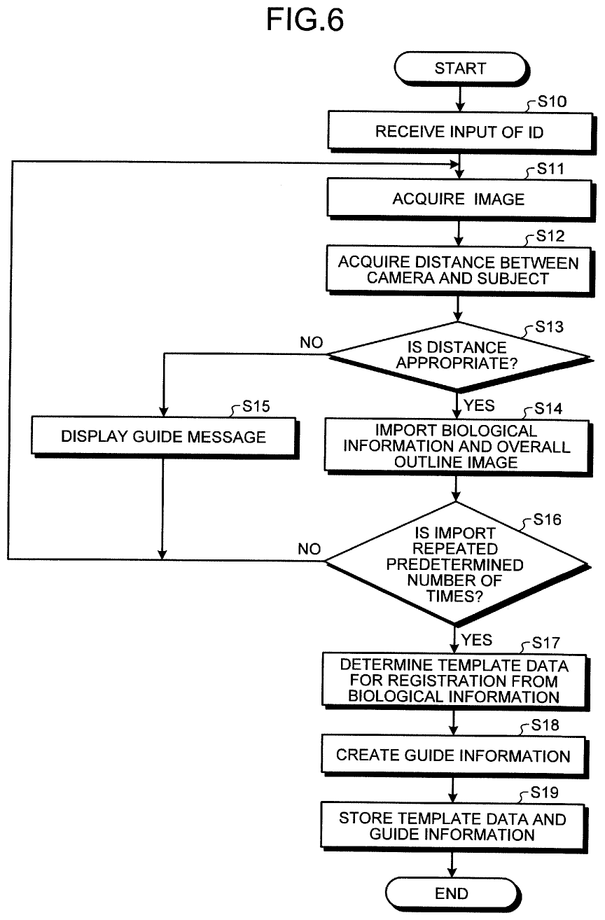

FIG. 6 is a flowchart illustrating an exemplary registration process performed by the control unit 10 of the electronic device 1 according to the embodiment. In the following registration, it is assumed that the ID has been registered in the registration file F1.

Referring to FIG. 6, the receiver 15a of the registration processor 15 receives an input of the ID (S10). For example, the receiver 15a displays the ID input screen (not illustrated) on the display 5 to receive an input of the ID, and determines whether the ID is registered in the registration file F1. The user operates the input unit 3 to input his or her ID to the ID input screen. When the registration file F1 contains no input ID received by the receiver 15a, the receiver 15a displays the ID input screen on the display 5 again.

When the registration file F1 contains the input ID received by the receiver 15a, the image acquirer 15b displays, on the display 5, a message (not illustrated) such as “Place your palm 200 in front of the camera 4”, and acquires the image 400 from the camera 4 (S11). Specifically, the image acquirer 15b receives the image 400 from the camera 4. The image 400 includes an image of the palm 200 since the user places the palm 200 in front of the camera 4.

Next, the image acquirer 15b acquires a distance from the camera 4 to the subject (in the present embodiment, the hand) (S12), and determines whether the distance is appropriate (S13). The distance from the camera 4 to the subject is along the optical axis of the camera 4. The range sensor 6 measures the distance from the camera 4 to the subject, and the image acquirer 15b acquires the measured distance from the range sensor 6. Alternatively, the distance from the camera 4 to the subject may be calculated from the image 400.

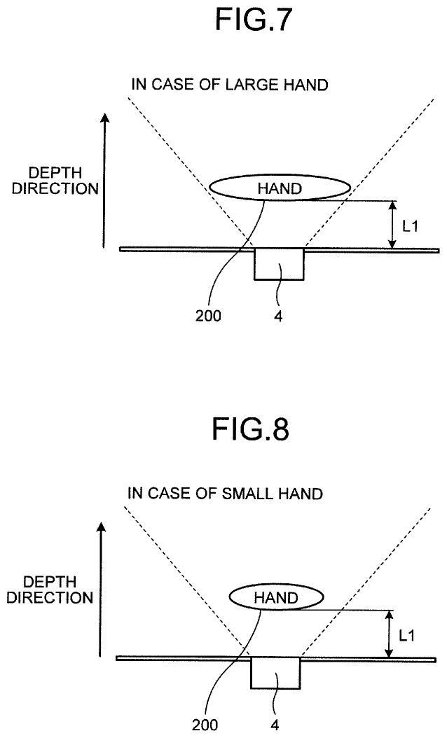

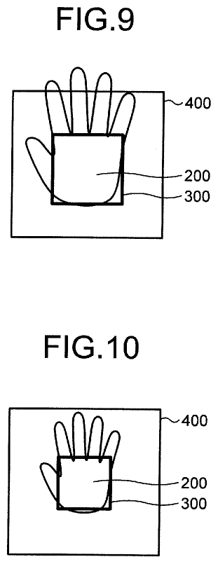

The following describes a position of the hand being a subject with respect to the camera 4. FIG. 7 is an explanatory diagram illustrating an example of placing a relatively large hand in front of the camera 4 in the embodiment. FIG. 8 is an explanatory diagram illustrating an example of placing a relatively small hand in front of the camera 4 in the embodiment. FIG. 9 is a diagram illustrating an exemplary image generated by the camera 4 in FIG. 7 in the embodiment. FIG. 10 is a diagram illustrating an exemplary image generated by the camera 4 in FIG. 8 in the embodiment.

As illustrated in FIG. 7 and FIG. 8, to generate an image of the hand with the camera 4, the hand is preferably distant from the camera 4 by a focal length L1 of the camera 4 irrespective of the size of the hand. In the imaging area of the camera 4 (upper side in FIG. 7 and FIG. 8), a direction away from the camera 4 along the optical axis is also referred to as a depth direction. FIG. 9 and FIG. 10 depict the image 400 generated in such a state. As can be seen from FIG. 9 and FIG. 10, the size of the hand in the image 400 varies depending on the actual size of the hand. Thus, the guiding shape 300 is set in accordance with the size of the hand, as described later. That is, the guiding shapes 300 set for the respective IDs may differ in shape and size.

Returning to FIG. 6, at S13, if an absolute value of a difference between the distance from the camera 4 to the subject and the focal length L1 of the camera 4 is equal to or smaller than a threshold, the image acquirer 15b determines that the distance from the camera 4 to the subject is appropriate (Yes at S13). In this case, the extractor 15c extracts, from the image 400, biological information and an overall outline image as an outline image of a human body part (S14). The biological information represents a vein image. With the absolute value of the difference between the distance from the camera 4 to the subject and the focal length L1 of the camera 4 exceeding the threshold, the image acquirer 15b determines that the distance between the camera 4 and the subject is not appropriate (No at S13). In this case, the image acquirer 15b displays, on the display 5, a guide message to prompt the user to move his/her hand to be in an appropriate distance (S15).

At S13, the image acquirer 15b may also determine by a known method whether the subject is located in an appropriate position with respect to the camera 4 in a direction orthogonal to the optical axis of the camera 4. In this case, after determining that the distance between the camera 4 and the subject and the position of the subject with respect to the camera 4 in the direction orthogonal to the optical axis of the camera 4 are not appropriate (No at S13), the image acquirer 15b displays, on the display 5, a guide message for prompting the user to move his/her hand to be in an appropriate distance and an appropriate position (S15). After the image acquirer 15b determines that the distance between the camera 4 and the subject and the position of the subject with respect to the camera 4 in the direction orthogonal to the optical axis of the camera 4 are appropriate (Yes at S13), the extractor 15c extracts, from the image 400, the biological information and the overall outline image being an outline image of a human body part (S14).

The operations at S10 to S15 are repeated until reaching a predetermined number of times (No at S16). That is, the extractor 15c extracts the biological information and the overall outline image from each of a predetermined number of images 400 (Yes at S16).

Next, the extractor 15c determines template data to register in the registration file F1 from a predetermined number of items of biological information by a known method (S17). The extractor 15c can extract a candidate for the template data from each of the predetermined number of items of biological information, and set an average of the candidates as the template data. The template data refers to biological information template.

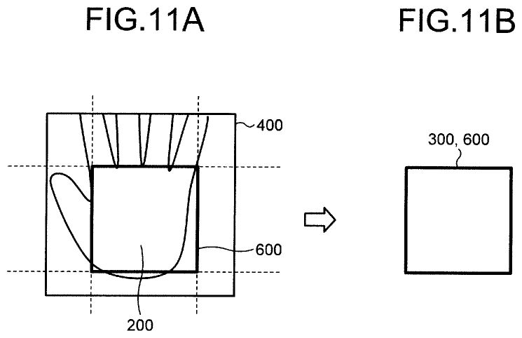

Next, the guide-information generator 15d generates the guide information Fb from the image 400 (S18). FIG. 11 is an explanatory diagram illustrating an exemplary method of extracting the outline image of the palm 200 in the embodiment. As illustrated in FIG. 11, first, the guide-information generator 15d extracts an outline image 600 of the palm 200 from the image 400 according to feature points representing such as the base of the fingers of the hand (in FIG. 11A). The outline image 600 of the palm 200 is extracted in a rectangular frame form (in FIG. 11B). The extractor 15c then determines the extracted outline image 600 as the guide information. That is, the extractor 15c sets the outline image 600 as the guiding shape 300.

Next, the registration processor 15 stores, in the registration file F1, the template data extracted by the extractor 15c and the guide information Fb generated by the guide-information generator 15d (S19). The registration processor 15 stores the template data and guide information for both of the right and left hands. The guide information Fb stored in the registration file F1 may be of either of the right and left hands or an average of the guide information Fb of the right and left hands.

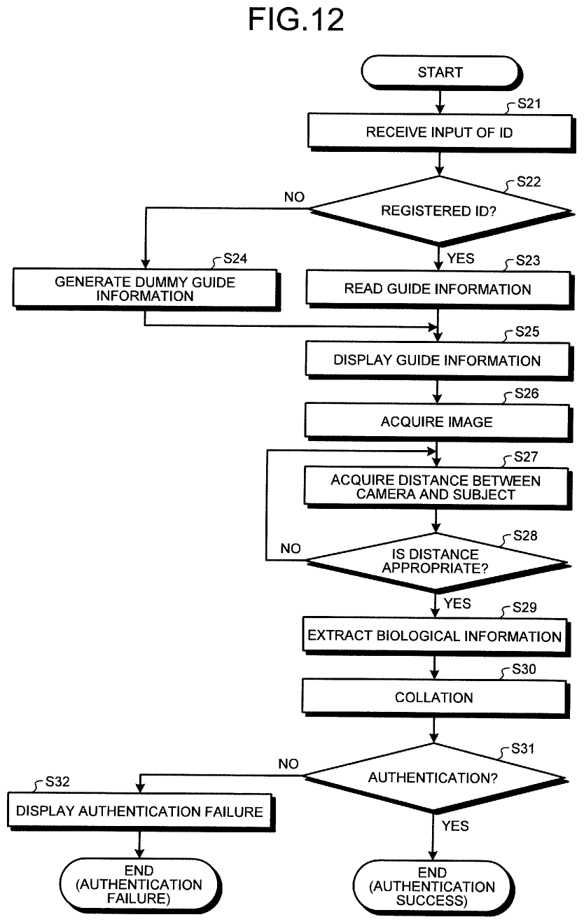

Next, the following describes the biometric authentication in detail. FIG. 12 is a flowchart illustrating exemplary authentication processing performed by the control unit 10 of the electronic device 1 according to the embodiment.

Referring to FIG. 12, the receiver 16a of the biometric authentication processor 16 receives an ID input (S21). For example, the receiver 16a displays the ID input screen on the display 5 (not illustrated) to receive an ID input. The user operates the input unit 3 to input his or her ID to the ID input screen.

If the registration file F1 contains the input ID received by the receiver 16a (Yes at S22), the guide display control 16b reads, from the registration file F1, the guide information Fb associated with the ID received at S21 (S23). The guide display control 16b displays the read guide information Fb on the display 5 (S25 in FIG. 12). Specifically, the guide display control 16b displays, on the display 5, the guiding shape 300 indicated by the read guide information Fb. For example, the guiding shape 300 is displayed on the guide screen 100 such that a predetermined part thereof is located at a predetermined position. The predetermined part of the guiding shape 300 is, for example, the center of the guiding shape 300. The predetermined part of the guiding shape 300 is not limited thereto. The guide display control 16b also displays, on the display 5, a message that “Place the palm 200 in front of the camera 4”, for example. The camera 4 starts imaging at this point. The image 400 generated by the camera 4 includes the image of the palm 200 since the user places the palm 200 in front of the camera 4.

Next, the image acquirer 16c acquires the generated image 400 from the camera 4 (S26). Specifically, the image acquirer 15b receives the image 400 from the camera 4.

Next, the image acquirer 15b acquires a distance between the camera 4 and the subject (hand) (S27). Next, the image acquirer 15b determines whether the distance acquired at S12 and the position of the subject with respect to the camera 4 are appropriate (S28). The operations at S27 and S28 are identical to the operations at S12 and S13 in FIG. 6, so that detailed description thereof is omitted. The operations at S26 to S28 are repeated while the distance and the position are not appropriate (No at S28).

After the image acquirer 15b determines the distance and the position as appropriate (Yes at S28), the authenticator 16d extracts biological information from the image 400 acquired at S26 by a known method (S29). That is, the authenticator 16d imports the biological information from the image 400.

The authenticator 16d reads, from the registration file F1, the collation-use biological information Fa associated with the ID received at S21, and collates the collation-use biological information Fa with the biological information extracted at S29 by a known method (S30). The authenticator 16d performs authentication based on a result of the collation at S28. For example, if a similarity between the collation-use biological information and the biological information extracted at S29 is equal to or larger than a predetermined value, the authenticator 16d authenticates the user, that is, determines a success in authentication (Yes at S31). If the similarity between the collation-use biological information and the biological information extracted at S29 is smaller than the predetermined value, the authenticator 16d refrains from authenticating the user, that is, determines a failure in authentication (No at S31). With a failure in authentication (No at S31), the authenticator 16d displays, on the display 5, information representing an authentication failure (S32).

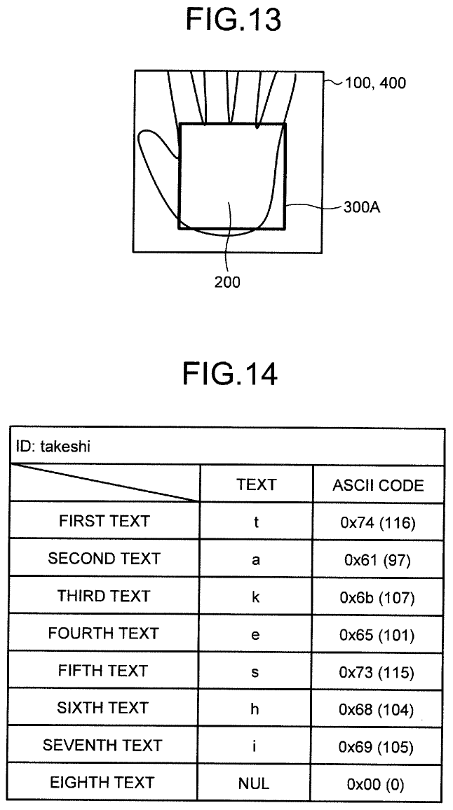

Next, the following describes an example that the registration file F1 does not contain the input ID received at S22 (No at S22). In this case, the guide display control 16b generates guide information representing a dummy guiding shape 300A (FIG. 13) (S24). The guide display control 16b then displays, on the display 5, the dummy guiding shape 300A represented by the dummy guide information (S25). The guide display control 16b sets the dummy guiding shape 300A corresponding to a not-registered ID. FIG. 13 is a diagram illustrating an example of the guide screen 100 displaying the dummy guiding shape 300A on the display 5 of the electronic device 1 of the embodiment. As illustrated in FIG. 13, the dummy guiding shape 300A has a rectangular frame shape as with the proper guiding shape 300. As with the guiding shape 300, for example, the dummy guiding shape 300A is displayed on the guide screen 100 such that a predetermined part thereof is located at a predetermined position. Hereinafter, the guide information representing the dummy guiding shape 300A is also referred to as dummy guide information.

The following describes a method of setting the dummy guiding shape 300A. For example, the guide display control 16b sets the dummy guiding shape 300A in accordance with ASCII codes of texts in the ID.

The guide display control 16b calculates a longitudinal length (guide height) of the dummy guiding shape 300A by the following expression (1), and calculates a lateral length (guide width) of the dummy guiding shape 300A by the following expression (2). A unit of the length is centimeter, by way of example.

Guide height=(the first text×the second text−the fifth text×the sixth text)/1000+100 (1)

Guide width=(the third text×the fourth text−the seventh text×the eighth text)/1000+100 (2)

The ASCII code corresponding to the text in the ID is input to the n^{th} text (n is a positive number) of the expressions (1) and (2).

FIG. 14 is a diagram illustrating a relationship between a certain ID (e.g., takeshi (male Japanese name)) and ASCII codes in the embodiment. The following results are obtained by substituting the ASCII codes of “takeshi” illustrated in FIG. 13 for the respective expressions (1) and (2).

Guide height=(116×97−115×104)/1000+100=99

Guide width=(107×101−105×0)/1000+100=110

As described above, for example, the guide display control 16b of the control unit 10 (biometric authentication device) according to the embodiment displays, on the display 5, the guiding shape, such as the proper guiding shape 300 and the dummy guiding shape 300A, for position adjustment of a predetermined part of a person with respect to the camera 4 and the image 400 acquired by the image acquirer 16c, irrespective of whether the ID received by the receiver 16a is registered in the registration file F1. This makes it difficult for the user to infer a registration status of the identification information. The proper guiding shape 300 is also referred to as a registered guiding shape or a first guiding shape while the dummy guiding shape 300A is also referred to as a non-registered guiding shape or a second guiding shape.

In the present embodiment, for example, when the registration file F1 does not contain the ID received by the receiver 16a, the guide display control 16b sets the dummy guiding shape 300A in accordance with the ID. This makes inference of the registration status of the identification information further difficult than use of the same dummy guiding shape 300A.

In the present embodiment, for example, the guiding shapes 300 and 300A are frame-like. Thus, the guiding shapes 300 and 300A of a relatively simple form can prevent increase in data amount of the guide information Fb. The guiding shapes 300 and 300A are not limited thereto. For example, the guiding shapes 300 and 300A may be cross-like or linear. The frame-like guiding shapes 300 and 300A are not limited to a rectangular shape. For example, the frame-like guiding shapes 300 and 300A may be circular, ellipsoidal, or polygonal other than rectangular. The guiding shapes 300 and 300A may have similar shapes of different sizes. The guiding shapes 300 and 300A may not be geometric. For example, the guiding shape may be a hand shape (predetermined part). In this case, the guide information Fb may be a hand image.

The guide display control 16b of the control unit 10 (biometric authentication device) of the embodiment acquires, for example, the guide information Fb associated with the ID received by the receiver 16a from the registration file F1 containing user IDs and the guide information Fb representing the geometric guiding shape 300 for position adjustment of the palm 200 (predetermined part) with respect to the camera 4 in association with each other. The guide display control 16b displays, on the display 5, the guiding shape 300 represented by the acquired guide information Fb and the image 400 acquired by the image acquirer 16c. Thus, the control unit 10 of the present embodiment can display the guiding shapes 300 suitable for each of two or more persons to authenticate without increase in the data amount of the guide information Fb, as compared with displaying a human body image as the guiding shape, for example. That is, the control unit 10 can perform the authentication process at a higher speed and reduce a data communication load.

In the present embodiment, the camera 4 is a wide-angle camera. This enables decrease in the distance between the palm 200 (predetermined part) of the user and the camera 4.

Next, the following describes modifications of the embodiment.

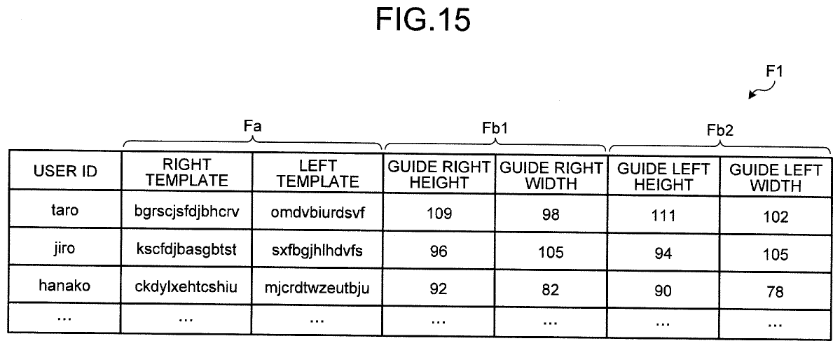

FIG. 15 is a diagram illustrating an exemplary registration file F1 according to a first modification of the embodiment. As illustrated in FIG. 15, in the present modification, the registration file F1 stores items of guide information Fb1 and Fb2 for the right and left hands (predetermined parts) of the person to authenticate, respectively. The guide information Fb1 represents the guiding shape for the palm 200 of the right hand of the user, and the guide information Fb2 represents the guiding shape for the palm 200 of the left hand of the user. In the present modification, the guide display control 16b displays either of the guiding shapes corresponding to the right and left hands on the display 5. In response to an operation to a right button (not illustrated), for example, the guide display control 16b displays the guiding shape represented by the guide information Fb1 on the display 5. In response to an operation to a left button (not illustrated), the guide display control 16b displays the guiding shape represented by the guide information Fb2 on the display 5.

According to the first modification, the guide display control 16b displays either of the guiding shapes 300 corresponding to the right and left hands (predetermined part) on the display 5, which improves users' usability and convenience, as compared with displaying only one of the right and left hands.

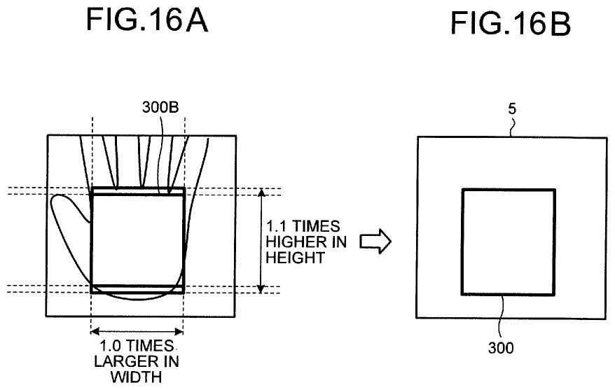

FIG. 16 is a diagram illustrating an exemplary method of determining the guiding shape 300 according to a second modification of the embodiment. As illustrated in FIG. 16, in the present modification, the guide-information generator 15d sets a magnification (relative value) with respect to a guiding shape 300B being a preset reference (in FIG. 16A). In the example of FIG. 16, the outer size of the extracted palm 200 is 1.1 times higher in height and 1.0 times larger in width than the reference guiding shape 300B. The magnification is not limited thereto. The guide-information generator 15d stores the magnification in the registration file F1 as the guide information Fb. The guide display control 16b displays the guiding shape 300 at the set magnification on the display 5 (in FIG. 16B).

The above embodiment has described the electronic device 1 integrally including the control unit 10 as an authentication device, the camera 4, and the display 5, as an example of the authentication system. However, the embodiment is not limited to such an example. The authentication device, the camera 4, and the display 5 of the authentication system may not be integrated together. The authentication device may be, for example, a server separated from the electronic device 1.

According to one aspect of this disclosure, for example, it is possible to provide a biometric authentication device and a computer program product which make inference of the registration status of identification information difficult.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A biometric authentication device comprising:
a receiver that receives an input of identification information of a person to authenticate;
an image acquirer that acquires an image of a predetermined part of the person to authenticate from a camera;
a guide display control that displays, on a display, a guiding shape and the image acquired by the image acquirer irrespective of whether the identification information received by the receiver is registered in a file containing registered identification information of persons, wherein the guiding shape is for position adjustment of the predetermined part with respect to the camera; and
an authenticator that authenticates the person based on the image acquired by the image acquirer.

2. The biometric authentication device according to claim 1, wherein
in response to no registration of the identification information received by the receiver in the file, the guide display control sets a dummy guiding shape in accordance with the identification information.

3. The biometric authentication device according to claim 1, wherein
the guiding shape is a frame shape.

4. A computer program product including programmed instructions embodied in and stored on a non-transitory computer readable medium, the instructions cause a computer executing the instructions to:
receive an input of identification information of a person to authenticate;
acquire an image of a predetermined part of the person to authenticate from a camera;
display, on a display, a guiding shape and the acquired image irrespective of whether the received identification information is registered in a file containing registered identification information of persons, wherein the guiding shape is for position adjustment of the predetermined part with respect to the camera; and
authenticates the person based on the acquired image.
